(19) United States
(12) Patent Application Publication
(10) Pub. No.: US 2009/0141318 A1
(43) Pub. Date: Jun. 4, 2009

(54) SECURE SCANNING SYSTEM

(76) Inventor: Terence J. HUGHES, Dunmore, PA (US)

Correspondence Address: ZALE Patent Law, 121 Old Orchard Road, Clarks Summit, PA, 18503-2053, US

(21) Appl. No.: 12/325,042

(22) Filed: Nov. 28, 2008

Related U.S. Application Data
(60) Provisional application No. 61/005,240, filed on Dec. 3, 2007.

(51) Int. Cl. H04N 1/04

(52) U.S. Cl. 358/498; 358/474

(57) ABSTRACT

The secure scanning device [1000] is described which includes a scanner [1300] a transport device [1510], a shredder [1900] all directed under the control of a computing device [1200]. Pages [3] of a confidential document intended to be scanned and securely stored are passed through the scanner [1300]. Images of the scanned pages [3] are provided to a user on a monitor [1230] of computing device [1200]. The user identified images that were not properly scanned. These are passed back through the scanner [1300] and re-scanned to acquire another image. Once proper images have been acquired, they are placed in the proper order in a secure electronic file. The pages [3] which have been properly scanned are sent to a shredder [1900] to be destroyed. The present invention will be very useful in reducing identity theft.

### CROSS REFERENCE TO RELATED APPLICATIONS

This application is a Continuation-In-Part of U.S. Provisional Patent Application Ser. No. 61/005,240 “Secure Scanning System” filed Dec. 3, 2007 by the same inventor as the present application, Terence J. Hughes, and claims priority from this application. All material set forth in the prior Provisional Patent Application is incorporated by reference as if set forth in its entirety herein.

### FEDERAL SPONSORED RESEARCH

Not Applicable

### SEQUENCE LISTING OR PROGRAM

Not Applicable

### BACKGROUND OF THE INVENTION

1. Field of the Invention

The present invention relates to a secure scanning system that shreds documents once they have been scanned and verified.

2. Discussion of Related Art

In the past there has been a problem with security of documents and information. This was caused by not immediately shredding confidential documents once they were scanned. These documents typically had been allowed then to lie around before being shredded. This allowed the documents to be stolen and used for other purposes, such as identity theft.

If documents were not checked to verify if an image was correctly scanned before sending the documents to be shredded, the information would be lost.

Therefore, users would manually verify each scan and shred each page manually. This becomes very time consuming and inefficient.

Prior art systems have not been able to automatically detect if a scanned image had been scanned properly. Each page would need to be checked manually. Pages which were incorrectly scanned had to be manually imaged again. These images would then manually be inserted to replace the incorrectly scanned page in the proper order in a multi-page scanned document.

Currently, there is a need for a scanner that scans the image, checks the image to make sure that it was scanned properly and to shred the documents before theft occurs.

### SUMMARY OF THE INVENTION

One embodiment of the present invention is a secure scanning device [1000] comprising:
a) a scanner [1300] for scanning document pages [3] provided to it and for creating electronic images from the scanned document pages [3];
b) a shredder [1900] for shredding document pages [3] provided to it;
c) a paper transport device [1530] for transporting document pages [3] from the scanner [1300] to the shredder [1900];
d) a computing device [1200] having a monitor [1230], the computing device [1200] coupled to the scanner [1300], the paper transport device [1530] and the shredder [1900] for controlling the scanner [1300], paper transport [1530] and the shredder [1900], adapted to:
   1. receive the electronic images for each scanned document page [3] from the scanner;
   2. display the electronic images on the monitor [1230],
   3. receive input indicating which document pages [3] have been scanned correctly,
   4. securely store the electronic images corresponding to the properly scanned document pages [3],
   5. activate the paper transport device [1530] to provide the properly scanned document pages [3] to the shredder [1900].
      The present invention may also be embodied as a secure scanning device [1000] for scanning document pages [3] comprising:
a) a switch [1030] which may be in a “scan only” position, a “shred only” position or a “scan and shred” position;
b) a digital storage device [1050] for storing electronic images provided to it;
c) a scanner [1300] for said scanning document pages [3] provided to it and for creating an electronic image from the scanned document pages [3], and securely storing the electronic images on the digital storage device [1050] when the switch [1030] is in the “scan only” position or the “scan and shred” position;
d) a shredder [1900] for shredding document pages [3] provided to it;
e) a holding bin [1770] for holding document pages [3];
f) a paper diverter [1170] coupled to the switch [1030] and the scanner [1300], for providing pages [3] to either the shredder [1900] for shredding when switch [1030] is in the “shred only” or “scan and shred” positions, or to the holding bin [1770] for storage when the switch [1030] is in the “scan only” position.
   The present invention may also be embodied as a secure scanning device [1000] comprising:
a) a scanner [1300] for scanning document pages [3] provided to it and for creating an electronic image from the scanned document pages [3];
b) a shredder [1900] for shredding document pages [3] provided to it;
c) a paper transport device [1530] for transporting document pages [3] from the scanner [1300] to the shredder [1900];
d) a computing device [1200] having a monitor [1230], the computing device [1200] coupled to the scanner [1300], the paper transport device [1530] and the shredder [1900] for controlling the scanner [1300], paper transport [1530] and the shredder [1900], adapted to:
   i. control the scanner [1300] to scan each page [3] provided to it into an electronic image,
   ii. receive the electronic images for each scanned document page [3] from the scanner,
   iii. securely store the electronic images,
   iv. display the electronic images on the monitor [1230],
   v. identify which document pages [3] have been scanned correctly, and document pages [3] which have not been correctly image, and
   vi. provide a first action for those document pages [3] which were correctly scanned, and a second action for those document pages [3] which were incorrectly scanned.

### OBJECTS OF THE INVENTION

It is an object of the present invention to provide a scanning system that will check each scanned image to make sure that each is correct.

It is another object of the present invention to provide a scanning system that re-scans incorrectly scanned images.

It is another object of the present invention to provide a scanning system that shreds documents after they have been properly scanned.

It is another object of the present invention to provide a scanning system which acquires information from confidential documents and securely stores it while destroying physical hard copies.

It is another object of the present invention to provide a scanning system which may selectively scan or shred documents or both scans and shreds documents.

### BRIEF DESCRIPTION OF THE DRAWINGS

The advantages of the instant disclosure will become more apparent when read with the specification and the drawings, wherein:

FIG. 1 is a perspective view of one embodiment of the secure scanning system 1000 according to the present invention.

FIG. 2 is a perspective view of another embodiment of the secure scanning system 1000 according to the present invention.

FIG. 3 is a perspective view of another embodiment of the secure scanning system 1000 according to the present invention.

FIG. 4 is a side elevational view of the embodiment of the secure scanning system 1000 shown in FIG. 3.

FIG. 5 is an illustration of another embodiment of a secure scanning system device 1000 according to the present invention.

### DETAILED DESCRIPTION OF THE INVENTION

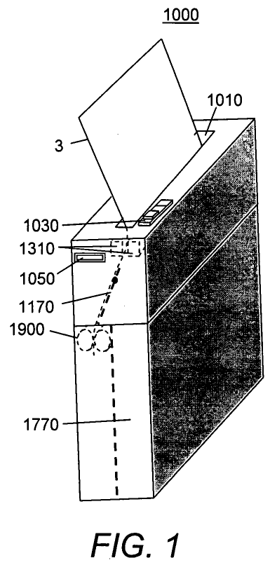

FIG. 1 is a perspective view of one embodiment of the secure scanning system 1000 according to the present invention. Here a page 3 of a confidential document intended to be scanned and/or shredded is placed in an input slot 1010.

A switch 1030 is set to either a “scan only” position, a “shred only” position or a “scan and shred position”.

When in the “scan only” position, page 3 will pass through input slot 1010 pass through scanning sensors 1310 in which an electronic image is acquired of page 3 which is securely stored in a digital storage device 1050, such as removable memory card 1050. The electronic images can only be opened with the use of a predetermined password. This removable memory card may be a USB flash drive, or that similar to the memory card used in digital cameras.

Paper diverter 1170 is coupled to switch 1030 and senses its position. In the “scan only” position, paper diverter 1170 guides page 3 into a holding bin 1770.

If switch 1030 is placed in the “scan and shred position”, the page 3 is passed though input slot 1010, through scanning sensors 1310 where an electronic image is acquired and saved on the digital storage device 1050. It is then passed to the shredder 1900 for shredding.

Paper diverter 1170 is coupled to and senses the position of switch 1030. When switch 1030 is in the “shred only” position, page 3 will be directed through scanning sensors 1310; however, no image is acquired. Paper diverter 1170 then directs page 3 into shredder 1900 where it will be shredded.

The secure scanning device [1000] can be built in a secure manner restricting access to the pages 3 stored inside of it. It may employ a lock or other locked mechanism.

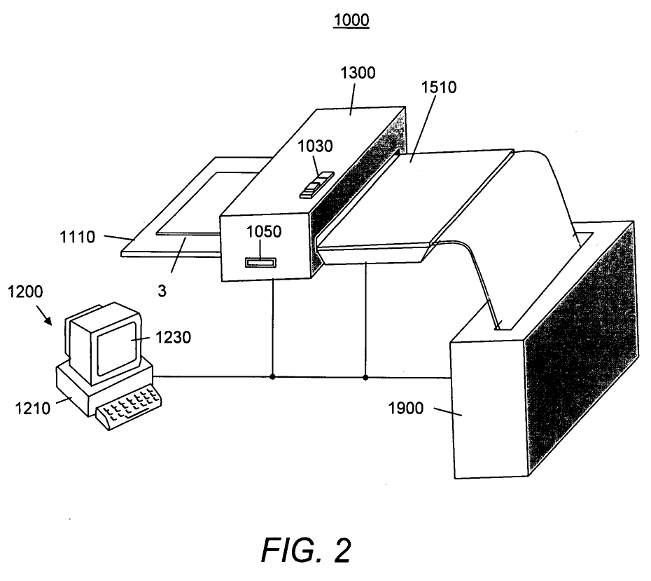

FIG. 2 is a perspective view of another embodiment of the secure scanning system 1000 according to the present invention. Here, pages 3 of a confidential document, such as a credit card statement, are fed to a scanner 1300 by an input device 1110.

The scanner 1300 scans the page 3 into a secure electronic file which is password protected and/or encrypted. This electronic file is sent to CPU 1210 of computing device 1200.

Optionally, this electronic file may be stored on a removable digital storage device 1050, such as a memory card. Preferably, the files are encrypted as they are stored so that the confidential information is safe in the event that the memory card 1050 is lost or stolen.

CPU 1210 creates an image that is displayed on monitor 1230. A user determines if page 3 was adequately scanned and interacts with computing device 1200 to either indicate that page 3 is to be shredded, or if it is intended to be re-scanned.

If the user indicates that page 3 has been properly scanned, then CPU 1210 causes page 3 to be sent to shredder 1900. Document 3 is then shredded in shredder 1900.

This embodiment of the secure scanning system 1000 may also include a switch 1030 having a “scan only” position, a “shred only” position and a “scan and shred position”.

When in the “scan only” position, page 3 will only be scanned and not sent to the shredder 1900. It will remain on paper transport device 1510.

When in the “shred only” position, page 3 will only be shredded.

When in the “scan and shred” position, page 3 will be scanned and shredded as described above.

This has been described with a generally horizontal paper path; however, the present invention may be implemented in an embodiment also having vertical and/or diagonal paper paths. This may also be implemented as a combination of all of these paper paths using conventional technology.

In an alternative embodiment of the invention, CPU 1210 may be a simple, limited functionality CPU and be built into the scanner 1300 or the shredder 1900. Similarly, monitor 1230 may be a small LCD screen built into the scanner 1300 or shredder 1900. This reduces the cost and complexity of the system.

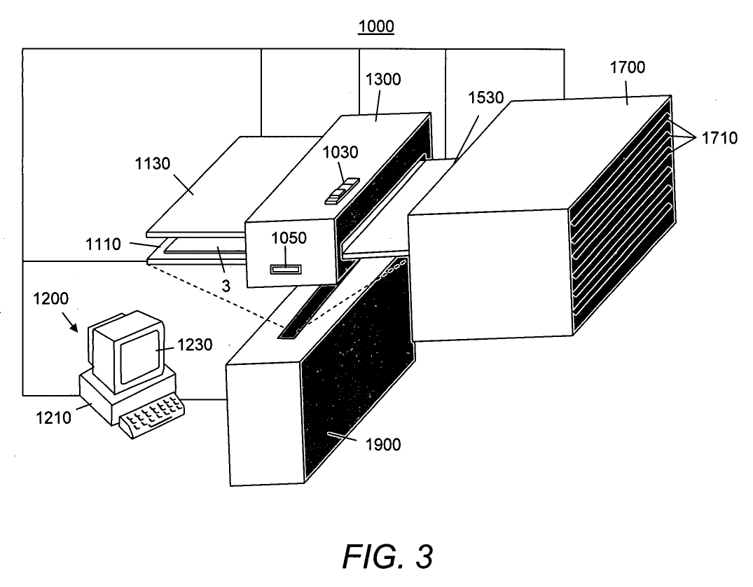

FIG. 3 is a perspective view of another embodiment of the secure scanning system 1000 according to the present invention. This is a more complex design allowing greater throughput. A plurality of pages 3 of a confidential document intended to be scanned and destroyed are placed on an input device 1110.

The input device 1110 moves each page 3 through a scanner 1300. Scanner 1300 creates an electronic image which is passed to the CPU 1210 of computing device 1200 where it is securely stored in a password-protected and/or encrypted manner.

Optionally, this electronic file may be stored on a digital storage device 1050, such as a removable memory card. Preferably, the files are encrypted as they are stored so that the confidential information is safe in the event that the memory card 1050 is lost or stolen.

A transport device 1530 moves page 3 to a storage device 1700. Storage device 1700 may have multiple bins 1710. These pages 3 may be stored in a number of these bins 1710. Each is noted to CPU 1210.

CPU 1210 displays the images of each scanned page 3 on a monitor 1230 to a user. The user views the scanned pages and indicates which, if any, have been improperly scanned. Since many pages will be scanned, a plurality of smaller images may be simultaneously displayed on monitor 1230. If a small image appears to be incorrect, it may be enlarged for a full view.

The user may also interact with the computing device 1200 to cause the improperly scanned pages 3 to be rescanned. Once a page 3 is identified by the user on computing device 1200, transport device 1530 finds the proper bin 1710 in storage device 1700. The proper page 3 is then identified and retrieved.

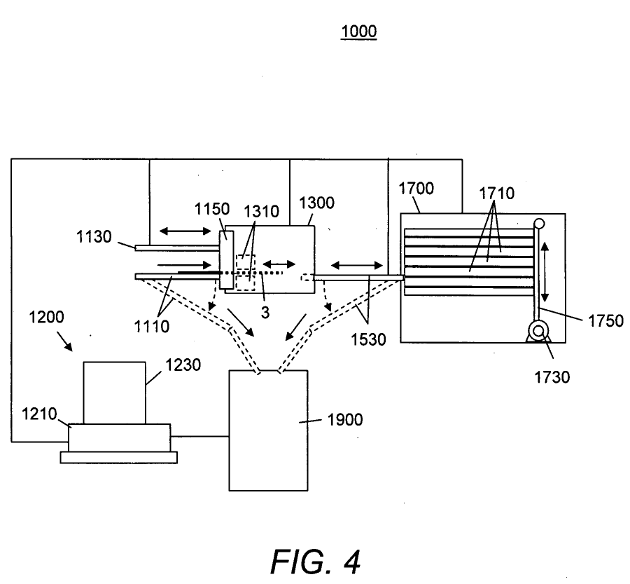

This page 3 is then passed back to a holding tray 1130 to be fed through scanner 1300 by feed mechanism (1150 of FIG. 4). A new image is now stored for this page 3 replacing the improperly scanned previous image.

This may then be repeated until all pages are properly scanned and stored.

The user interacts with computing device 1200 to cause all properly scanned pages to be shredded in shredder 1900.

As described above, there may be a switch 1030 which allows a user to select “scan only”, “shred only” or “scan and shred”. The above description relates to “scan and shred”.

In the “scan only” position, after being scanned and placed in the bins 1710, they may be taken out of the bins 1710 in the proper order and passed to holding tray 1130.

In the “shred only” position, input device 1110 may angle downward to directly feed the pages 3 to shredder 1900 bypassing scanner 1300.

FIG. 4 is side elevational view of the embodiment of the secure scanning system 1000 shown in FIG. 3. In this view it can be seen that each page 3 is moved by a feed mechanism 1150 past a set of scanning sensors 1310 and out of scanner 1300.

Transport device 1530 may be a tray with rollers which grab and pull page 3 to move it toward a bin 1710 in storage device 1700. Transport device 1530 may also be a conveyor or other known technology for paper transport.

Storage device 1700 may be designed such that the bins 1710 may be elevated or lowered. This allows transport device to insert page 3 into any of the bins depending upon the positioning of the bins 1710. This may be accomplished by having a drive unit 1750 attached to the bins and a motor 1730 activate the drive unit 1750 to raise and lower the bins 1710.

In the event that one or more of the pages 3 have been improperly scanned, CPU identifies the bins where the pages are being stored and may control motor 1730 to cause the proper bin 1710 to line up with transport device 1530. The proper page 3 is then taken from bin 1710, and passed back through scanner 1300 to a holding tray 1130. Conventional paper transport devices may be used to divert page 3 to holding tray 1130.

Page 3 then is brought in by feed mechanism 1150 and scanned again. The rescanned image is then properly inserted into the electronic document at its proper page location.

When the user indicates that one or more pages 3 are to be shredded, transport device 1530 may be angled downward. Storage device 1700 allows the proper page to be taken from its bin 1710 and passed to shredder 1900.

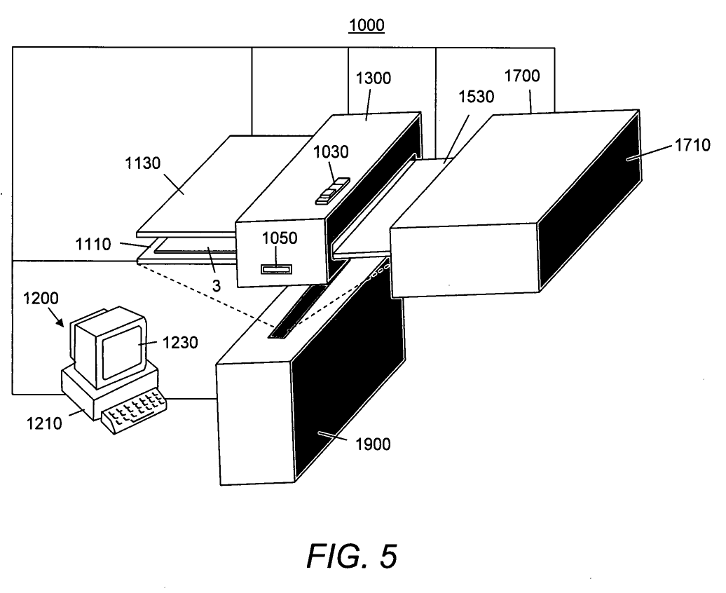

FIG. 5 is an illustration of another embodiment of a secure scanning system 1000 according to the present invention. This embodiment functions in a similar manner as in the previous embodiment, except there is only a single bin 1710 in storage device 1700.

The pages 3 of a confidential document intended to be scanned and destroyed are placed on an input device 1110.

A feed mechanism (1150 of FIG. 4) moves each page 3 through a scanner 1300. Scanner 1300 creates an electronic image which is passed to a CPU 1210 of a computing device 1200 where it is securely stored in a password-protected and/or encrypted manner.

Optionally, this electronic file may be stored on a digital storage device 1050, such as a removable memory card. Preferably, the files are encrypted as they are stored so that the confidential information is safe in the event that the digital storage device 1050 is lost or stolen.

A transport device 1530 moves the pages 3 to storage device 1700 where they are stored. Each page position is noted to CPU 1210.

In this embodiment, CPU 1210 counts the pages being put into storage device 1700.

CPU 1210 displays the images of each scanned page 3 on a monitor 1230 to a user. The user views the scanned pages and indicates which, if any, have been improperly scanned. Since many pages will be scanned, smaller images may be simultaneously displayed on monitor 1230. If a small image looks incorrect, it may be examined on an enlarged view.

The user may also interact with the system to cause the improperly scanned pages 3 to be re-scanned. Once a page 3 is identified by the user on computing device 1200, transport device 1530 finds the proper page in storage device 1700. All pages prior to the proper page 3 are passed to the holding tray 1130.

Page 3 is then fed through scanner 1300 to input device 1110. Page 3 is then re-scanned. A new image is now stored for this page 3 replacing the improperly scanned image.

Other pages which are not intended to be re-scanned are simply passed through the scanner 1300 without acquiring another image, and stored back in the storage device 1700 in their proper order.

Although a single page was re-scanned in the description above, multiple pages may be identified and re-scanned using this system and method.

Using FIG. 3 as an example, an alternative embodiment of the present invention, computing device 1200 can flag potentially incorrectly scanned document pages 3. One method would be to check the top, bottom and/or side edges of the scanned image of page 3. If they are angled more than a minimal amount, it is determined that the page was possibly mis-fed and incorrectly scanned. This minimal threshold amount may be selected based upon the sensitivity desired. One example would be having an edge angled more than a 5% deviation from horizontal or vertical would trigger an indication of an improperly scanned image. A user viewing the image on computing device 1200 may then verify if it was incorrectly scanned. Other deviation thresholds may also be used.

Another method of indicating if a page is incorrectly scanned is to identify if there are lines of text on the page. If so, the angle these lines make with the edges of the page will indicate improper scanning. If they are substantially parallel to the top and bottom edges, it is a correct scan.

Another indicator would be large dark artifacts on the electronic image.

In another alternative embodiment, incorrectly scanned document pages 3 may be automatically identified as above and the incorrectly scanned document pages set aside while the properly scanned pages are separated to be shredded.

The improperly scanned document page 3 can be scanned into another electronic image to replace the electronic image from the improper scan of that page.

Other modifications and changes of the embodiments described above made to fit particular operating requirements and environments will become apparent to those of ordinary skill in the art. The invention is not considered limited to the specific example chosen for the purposes of disclosure, and covers all changes and modifications which do not depart from the true spirit and scope of this invention.

What is claimed is:

1. A secure scanning device [1000] for scanning document pages [3] comprising:
a) a switch [1030] which may be in a “scan only” position, a “shred only” position or a “scan and shred” position;
b) a digital storage device [1050] for storing electronic images provided to it;
c) a scanner [1300] for said scanning document pages [3] provided to it and for creating an electronic image from the scanned document pages [3], and securely storing the electronic images on the digital storage device [1050] when the switch [1030] is in the “scan only” position or the “scan and shred” position;
d) a shredder [1900] for shredding document pages [3] provided to it;
e) a holding bin [1770] for holding document pages [3];
f) a paper diverter [1170] coupled to the switch [1030] and the scanner [1300], for providing pages [3] to either the shredder [1900] for shredding when switch [1030] is in the “shred only” or “scan and shred” positions, or to the holding bin [1770] for storage when the switch [1030] is in the “scan only” position.

2. The secure scanning device [1000] wherein the digital storage device [1050] is a memory card.

3. The secure scanning device [1000] wherein the holding bin [1770] is a secure container.

4. A secure scanning device [1000] comprising:
a) a scanner [1300] for scanning document pages [3] provided to it and for creating an electronic image from the scanned document pages [3];
b) a shredder [1900] for shredding document pages [3] provided to it;
c) a paper transport device [1530] for transporting document pages [3] from the scanner [1300] to the shredder [1900];
d) a computing device [1200] having a monitor [1230], the computing device [1200] coupled to the scanner [1300], the paper transport device [1530] and the shredder [1900] for controlling the scanner [1300], paper transport [1530] and the shredder [1900], adapted to:
vii. control the scanner [1300] to scan each page [3] provided to it into an electronic image,
viii. receive the electronic images for each scanned document page [3] from the scanner,
ix. securely store the electronic images,
x. display the electronic images on the monitor [1230],
xi. identify which document pages [3] have been scanned correctly, and document pages [3] which have not been correctly image, and
xii. provide a first action for those document pages [3] which were correctly scanned, and a second action for those document pages [3] which were incorrectly scanned.

5. The secure scanning device [1000] of claim 4, wherein the first action is to cause the paper transport device [1530] to pass the correctly scanned pages [3] to the shredder [1900] to be shredded.

6. The secure scanning device [1000] of claim 4, wherein the first action is to cause the paper transport device [1530] to pass the correctly scanned pages [3] to a holding bin [1770] to be separated from the incorrectly scanned pages [3].

7. The secure scanning device [1000] of claim 4, wherein the first action is to cause the paper transport device [1530] to pass the incorrectly scanned document pages [3] to the scanner [1300] to acquire a re-scanned image.

8. The secure scanning device [1000] of claim 4, wherein the first action is to cause the paper transport device to pass the incorrectly scanned pages [3] to a holding bin [1770] to be separated from the correctly scanned pages [3].

9. The secure scanning device [1000] of claim 4, wherein the computing device [1200] is further adapted to check the re-scanned images and if correct, to replace the incorrectly scanned images with their re-scanned images.

10. The secure scanning device [1000] of claim 4, wherein the computing device [1200] determines if an image is correctly scanned by identifying if any print margins exist in the scanned image, and if so, if they are substantially parallel to a side of the scanned image.

11. The secure scanning device [1000] of claim 4, wherein the computing device [1200] determines if an image is correctly scanned by identifying if there are any large print artifacts on the electronic image.

12. The secure scanning device [1000] of claim 4, wherein artifacts are large dark areas.

13. The secure scanning device [1000] of claim 4, wherein the computing device [1200] determines if an image is correctly scanned by identifying if there are lines of text and if so, if the lines of text are substantially parallel to a top or bottom edge of the scanned image.

14. The secure scanning device [1000] of claim 4, wherein the correctly scanned images are immediately stored in an encrypted format.

15. The secure scanning device [1000] of claim 4, wherein security is required to view the images.

16. The secure scanning device [1000] of claim 4, wherein a proper password must be input to the system before a user is allowed to view the electronic images.
